(19) United States
(12) Patent Application Publication
(10) Pub. No.: US 2015/0248693 A1
(43) Pub. Date: Sep. 3, 2015

(54) DYNAMIC MODIFICATION OF TARGETING CRITERIA

(71) Applicant: LinkedIn Corporation, Mountain View, CA (US)

(72) Inventor: Sanjay Sureshchandra Dubey, Fremont, CA (US)

(21) Appl. No.: 14/539,143

(22) Filed: Nov. 12, 2014

Related U.S. Application Data
(60) Provisional application No. 61/946,499, filed on Feb. 28, 2014.

(51) Int. Cl. G06Q 30/02

(52) U.S. Cl. CPC G06Q 30/0244; G06Q 30/0246; G06Q 30/0251

(57) ABSTRACT

A machine may be configured to perform dynamic modification of targeting criteria to increase the click-through-rate of an advertising campaign that includes one or more advertisements. According to various example embodiments, an advertiser selects for a particular advertisement an initial set of member profile attributes and characteristics as initial member-targeting criteria and specifies a group of members of a social networking service to be presented with the advertisement. The advertisement is presented to the group of members satisfying the initial member-targeting criteria, and resulting click-through rate rates for various subsets of the group are analyzed to identify high-performing and low-performing segments. Based on these results, the member-targeting criteria are dynamically modified to target the high-performing segments of the social networking service.

### RELATED APPLICATION

This application claims the priority benefit of U.S. Provisional Patent Application No. 61/946,499, filed Feb. 28, 2014, which is incorporated herein by reference in its entirety.

### TECHNICAL FIELD

The subject matter disclosed herein generally relates to machines that are configured to process data (e.g., data processing systems). Specifically, the present disclosure addresses systems, methods, and computer program products that facilitate dynamic modification of targeting criteria (e.g., dynamic modification of an advertisement targeting criteria for improving rates of response to an advertising campaign, for example, as measured by a click-through rate (CTR)).

### BACKGROUND

Many online or web-based social networking services maintain a variety of personal information about their members (e.g., users who are registered members). For instance, with many social networking services, when a user registers to become a member, the member is prompted to provide a variety of personal information (e.g., biographical information), which may be displayed via a member's personal web page. Such personal information is commonly referred to as member profile information, or simply “profile information,” and when the profile information of a member is shown collectively, it is commonly referred to as that member's profile. For instance, with some of the social networking services in use today, the personal information that is commonly requested and displayed as part of a member's profile includes a person's age or birthdate, gender, interests, contact information, residential address (e.g., home town, state, or both), the name of the person's family members (e.g., spouse), or any suitable combination thereof. With certain social networking services, such as some business or professional networking services, a member's personal information may include information commonly included in a professional resume or curriculum vitae, such as information about the member's education, the company at which the member is employed, an industry in which the member is employed, the member's job title or function, the member's employment history, skills possessed by the member, professional organizations that the member has joined, or any suitable combination thereof.

Because social networking services may maintain extensive and rich information about their members, companies and other organizations may wish to direct advertisements to various subsets (e.g., segments) of the population of members of a social networking service. Accordingly, a social networking service may provide one or more advertisement services that enable third parties to present advertisements only to selected members of the social networking service and not to other members of the social networking service. However, advertisers may not be well-informed regarding which particular subsets (e.g., segments) of the population of members to target with a given advertisement. Consequently, the success of a given advertising campaign (e.g., as measured by CTR) may be sub-optimal.

### BRIEF DESCRIPTION OF THE DRAWINGS

Some embodiments are illustrated by way of example and not limitation in the figures of the accompanying drawings.

FIG. 1 is a network diagram illustrating a network environment suitable for dynamic modification of targeting criteria, according to some example embodiments.

FIG. 2 is a block diagram illustrating components of a server machine, according to some example embodiments.

FIG. 3 is a block diagram illustrating various components or functional modules of a social networking service, according to some example embodiments.

FIG. 4 is a user interface diagram illustrating an example of a member-targeting interface, according to some example embodiments.

FIG. 5 is a diagram illustrating at a conceptual level how targeting criteria for an advertising campaign may dynamically change over time to increase the CTR for the advertising campaign, according to some example embodiments;

FIG. 6 is a flow diagram illustrating an example of operations in a method for dynamically targeting subsets of members of a social networking service, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to systems, methods, and computer program products that individually facilitate dynamic modification of targeting criteria. Such methods, systems, and computer program products may each individually implement a dynamic member-targeting scheme by which member-targeting criteria for an advertising campaign are automatically (e.g., continuously and dynamically) modified by a machine to improve the rate at which those who are presented with an advertisement interact with that advertisement, for example, by selecting (e.g., clicking on) the advertisement. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In the context of online advertising, an impression occurs when an advertisement is presented or displayed to a user, regardless of whether the user selects (e.g., clicks on) any part (e.g., a selectable element, such as an image or link) of the advertisement. Counting impressions is a popular method by which web-based advertising is accounted and paid for. However, in many advertising schemes, payment is based not on impressions, but on a count of the number of viewers of an advertisement who, when presented with the advertisement, initiate some action with respect to the advertisement. Typically, although not always, the action is referred to as a “click” (e.g., as in a computer mouse click). Other interactions, such as the selection of an element of an advertisement by means of a touch-based gesture in the case of a touch-based display, are typically understood to be within the meaning of the term “click.” Accordingly, a CTR is a measure of the success of an advertising campaign, and may be defined, calculated, or otherwise derived as the number of clicks divided by the number of impressions for a particular advertisement over a period of time (e.g., an hour, a day, a month, the duration of an advertising campaign, or any portion thereof).

Typically, when an advertiser creates an advertising campaign targeting members of a social networking service, the advertiser will target a specific segment of members to be presented with an advertisement by selecting or specifying a set of attributes or characteristics possessed by the targeted members (e.g., member-targeting criteria). Accordingly, for purposes of the present document, a “segment” or “member segment” is a subset or population of members of a social networking service who have attributes or characteristics that satisfy some member-targeting criteria. For example, a company that makes and sells ski equipment might target members who live in certain geographical areas (e.g., mountainous areas) and who fall within a certain age range. Such members of the social networking service who satisfy the advertiser-selected targeting criteria may therefore represent a particular subset (e.g., segment) of all members of the social networking service. When a member of the social networking service is viewing a particular web page or user interface, an advertisement server may identify the various advertisements having associated member-targeting criteria satisfied by the attributes and characteristics of the member viewing the web page or user interface. The advertisement server may then select an advertisement, based on the attributes and characteristics of the viewing member, to serve or embed within the web page or user interface being viewed by the member.

In many instances, given an opportunity to present a particular member with an advertisement, there may be a significant number of potential advertisements that could be presented to the member. For example, a member of a social networking service viewing a particular web page or user interface may have member profile attributes that satisfy advertiser-specified member-targeting criteria for any number of advertisements. In a bid-based advertising system, one criterion for selecting from among all of the eligible potential advertisements is the bid price, where the advertisement having the highest bid generally takes preference for presentation to the member. However, with an advertising scheme in which payment is based on clicks (as opposed to impressions), the advertisement selection algorithm may be enhanced by taking into consideration the likelihood that a particular member will interact with (e.g., click on) an advertisement when presented with that advertisement. Various example embodiments of the systems, methods, and computer program products discussed herein aim to dynamically adjust the targeted subset (e.g., targeted segment) of members of a social networking service for a given advertising campaign, thereby changing the attributes and characteristics of the members who are ultimately viewing a particular advertisement, with a view to increasing the CTR for the particular advertising campaign. By dynamically changing one or more of the targeted subsets of members (e.g., to include subsets more likely to interact with an advertisement), the likelihood that any particular member will interact with the advertisement is increased, thereby providing benefits to both the advertising entity and the advertisement serving entity or content host (e.g. the operator of the social networking service).

For instance, in some example embodiments, advertisers benefit because an advertiser can run an advertising campaign that dynamically adjusts to obtain a high CTR, even when the advertiser is uncertain of the optimal targeting criteria to use in defining the subset (e.g., segment) of members to whom the advertisement should be presented. For a particular advertising campaign, by electing or otherwise opting into the dynamic targeting scheme described herein, the advertiser may benefit by having the initial advertiser-selected targeting criteria become dynamically modified over time to remove one or more under-performing subsets, and add one or more high-performing subsets. This dynamic modification of the targeting criteria may be based at least in part on the historical performance of the actual advertisement, or in some cases, the historical performance of advertisements associated with other advertising campaigns that are deemed to be similar to the advertisement at issue.

To identify the under-performing and high-performing subsets (e.g., a subset of members having a low (under-performing) or high (high-performing) probability of selecting or clicking on an advertisement), in some example embodiments, an explore-and-exploit approach is used. For example, in certain example embodiments, over a particular period of time (e.g., one day or one week), a particular advertisement is served to members having attributes and characteristics satisfying the initial (e.g., advertiser-chosen) member-targeting criteria. Then, the attributes and characteristics of the particular members who were presented with the advertisement are analyzed to identify the specific attributes and characteristics that are most common among those members who selected or clicked on the advertisement (e.g., a high-performing segment), and the specific attributes and characteristics that are most common among those members who did not select or click on the advertisement (e.g., an underperforming segment). One or more new subsets (e.g., new segments) may then be defined by targeting members having some or all of the attributes and characteristics shared in common amongst members of the high-performing subset (e.g., high-performing segment), and not having some or all of the attributes and characteristics shared in common amongst members of the under-performing subset (e.g., under-performing segment). This process may be repeated over successive time periods until the benefit (e.g., in terms of increased CTR) is no longer detected (e.g., observed).

In some example embodiments, as part of the dynamic targeting scheme, one or more additional segments may be automatically selected for an advertising campaign by automatically including subsets that correspond to member-targeting criteria that have historically been associated with a high CTR for one or more advertisements that are similar to the advertisement of the present advertising campaign. For instance, if historical data suggest that members possessing a particular attribute or characteristic have a high propensity for selecting or clicking on an advertisement relating to a particular topic (e.g., automobiles or electronics), when a new advertising campaign corresponding to that same topic is initiated, an advertiser-specified subset (e.g., initial advertiser-selected segment) may be modified to include (e.g., as member-targeting criteria) certain member attributes or characteristics possessed by the subsets (e.g., segments) that have historically shown a propensity for clicking or selecting advertisements known to be associated with the topic to which the new advertising campaign relates.

In certain example embodiments, during an advertising campaign, the original advertiser-selected subset or subsets (e.g., one or more initial segments) may be modified (e.g., dynamically revised) or omitted (e.g., deleted), and one or more new subsets may be added, so long as the revised and new subsets exhibit a benefit in terms of an increased CTR. Accordingly, when a new or revised segment is generated for the advertising campaign, a certain number of impressions may be allocated to a new or revised subset so that the performance (e.g., the CTR) of the new or revised segment can be ascertained. If the CTR meets or exceeds a predetermined threshold, additional advertisement impressions may be allocated to the particular new or revised segment. In some example embodiments, the CTR is also the highest CTR compared to one or more other segments (e.g., in addition to meeting or exceeding the predetermined threshold). The exact threshold for determining the level of benefit that justifies allocation of additional advertisement impressions may vary from one example embodiment to the next. For example, with some example embodiments, a particular advertisement may be served to a new or revised segment so long as the CTR for that segment exceeds the CTR of the initial advertiser-specified segment. In other example embodiments, the allocation of additional impressions occurs only if the CTR for the new or revised segment exceeds the CTR of an original advertiser-specified segment by some percentage. In various example embodiments, the dynamic targeting scheme may continue to revise segments, omit segments, or add segments as long as there continues to be a benefit in terms of an increased CTR. Other aspects and advantages of the present inventive subject matter will be readily apparent to the skilled artisan from the descriptions of the figures that follow.

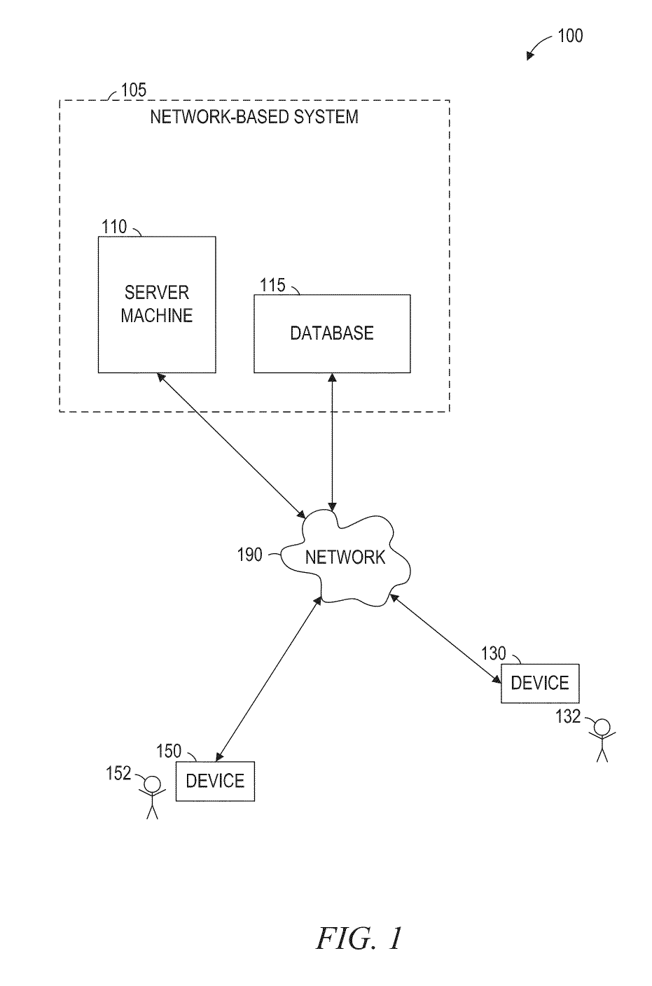

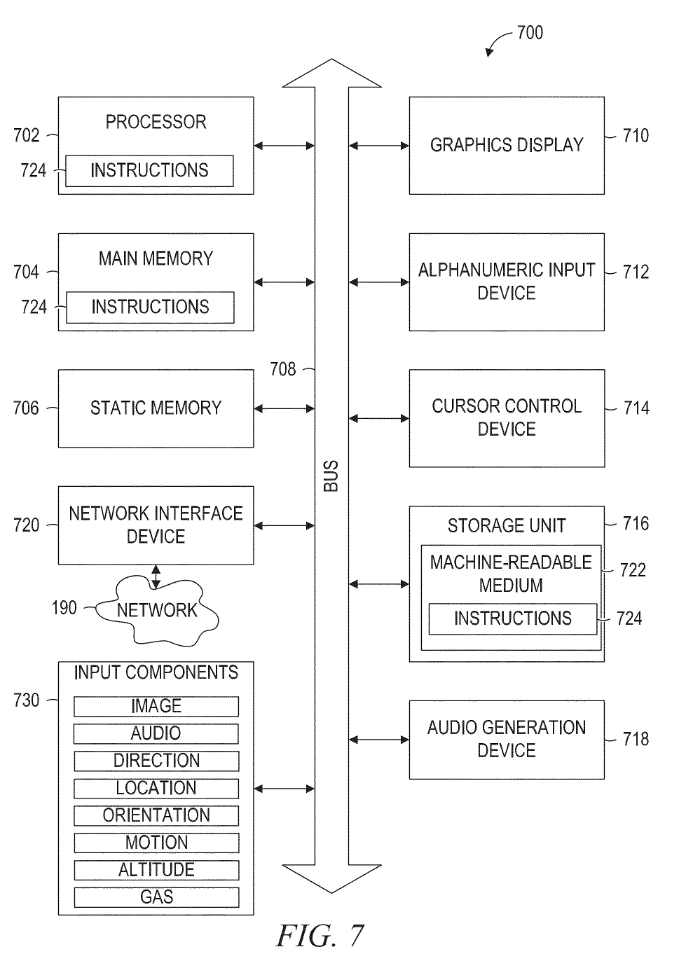

FIG. 1 is a network diagram illustrating a network environment 100 suitable for dynamic modification of targeting criteria, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more social networking services, online advertising services, or both, to one or more of the devices 130 and 150). The server machine 110 and the devices 130 and 150 may each be implemented in a computer system, in whole or in part, as described below with respect to FIG. 7.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a special-purpose computer that has been modified (e.g., configured or programmed) by software (e.g., one or more software modules) to perform one or more of the functions described herein for that machine, database, or device. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

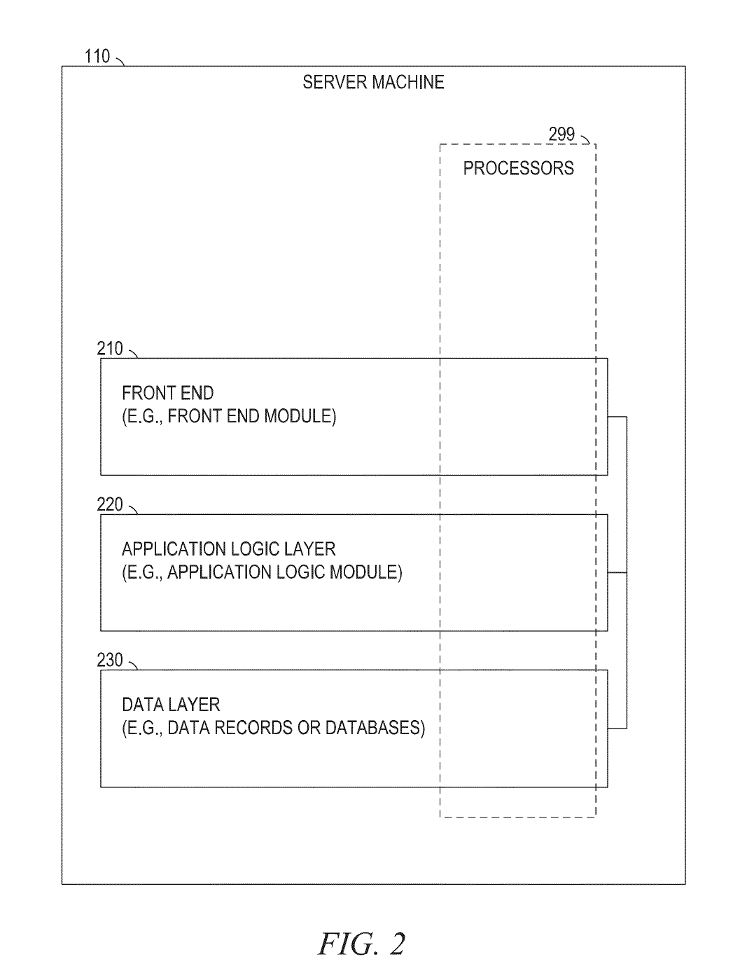

FIG. 2 is a block diagram illustrating components of the server machine 110, according to some example embodiments. The server machine 110 is shown as including a front end 210 (e.g., a front end module), an application logic layer 220 (e.g., an application logic module), and a data layer 230 (e.g., one or more data records or databases), all configured to communicate with each other (e.g., via a bus, shared memory, or a switch).

Any one or more of the modules described herein may be implemented using hardware alone (e.g., one or more processors 299 of a machine) or a combination of hardware and software. For example, any module described herein may physically include an arrangement of one or more processors 299 (e.g., a subset of or among the one or more processors of the machine) configured to perform the operations described herein for that module. As another example, any module described herein may include software, hardware, or both, that configure an arrangement of one or more processors 299 (e.g., among the one or more processors of the machine) to perform the operations described herein for that module. Accordingly, different modules described herein may include and configure different arrangements of such processors 299 or a single arrangement of such processors 299 at different points in time. Moreover, any two or more modules described herein may be combined into a single module, and the functions described herein for a single module may be subdivided among multiple modules. Furthermore, according to various example embodiments, modules described herein as being implemented within a single machine, database, or device may be distributed across multiple machines, databases, or devices.

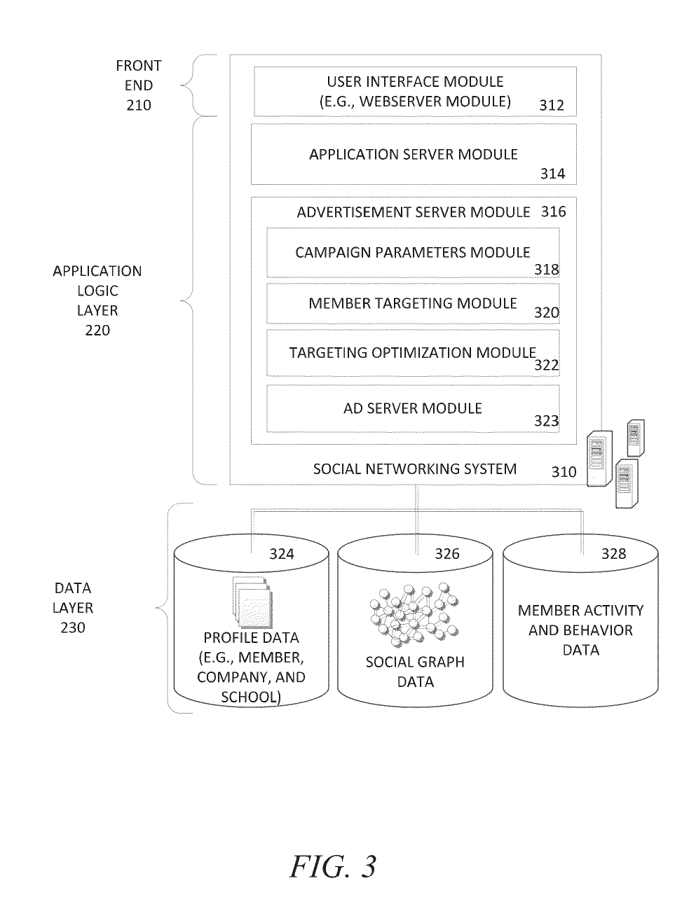

FIG. 3 is a block diagram illustrating various components or functional modules of a social networking service (e.g., provided by the network-based system 105) including an advertisement server module 316, consistent with some example embodiments. The server machine 110 may form all or part of a social networking system 310 that includes the front end 210 and the application logic layer 220. The data layer 230 may be implemented in the server machine 110, the database 115, or any suitable combination thereof. As shown in FIG. 3, the front end 210 includes a user interface module 312 (e.g., a webserver module), which receives requests from various client-computing devices (e.g., devices 130 and 150), and communicates appropriate responses to the requesting client devices (e.g., device 130 and 150). For example, the user interface module 312 may be configured to receive requests in the form of Hypertext Transport Protocol (HTTP) requests, or other web-based, application programming interface (API) requests.

The application logic layer 220 includes an application server module 314, which may be configured to process API requests and which, in conjunction with the user interface module 312, may be configured to generate various user interfaces (e.g., web pages) with data retrieved from various data sources in the data layer 230. In some example embodiments, individual submodules within the application server module 314 are used to implement the functionality of various individual applications, services, or features of the social networking service hosted by the network-based system 105. For instance, a social networking service may provide a broad variety of applications and services. Examples include the ability to search or browse member profiles, job listings, and news articles. Other examples of such applications and services may allow members (e.g., users 132 and 152) to share content with one another, for example, via email, messages, a content stream (e.g., activity stream, sometimes referred to as an update stream), or a newsfeed. A wide variety and number of other applications or services may be made available to members of a social networking service and may generally be embodied in their own instances of one or more submodules of the application server module 314.

The social networking service (e.g., as provided by the network-based system 105) may provide a broad range of applications and services that allow members (e.g., users 132 and 152) the opportunity to share and receive information, often customized to the interests of the member. For example, the social networking service may include a photo sharing application that allows members to upload and share photos with other members. In some example embodiments, members may be able to self-organize into groups (e.g., interest groups) organized around a subject matter or topic of interest. In certain example embodiments, the social networking service may host various job listings providing details of job openings with various organizations (e.g., companies). Accordingly, consistent with various example embodiments, members of the social networking service can search for and browse active job listings, and may use (e.g., leverage) their member profile information in completing an online job application for one or more of such active job listings.

As shown in FIG. 3, the data layer 230 includes one or more databases, such as a profile database 324 for storing profile data, which may include member profile data, as well as profile data for various organizations and entities represented in a social graph maintained by the social networking service. Consistent with some example embodiments, when a user (e.g., user 132) initially registers to become a member of the social networking service, the user is prompted to provide some personal information, such as his or her name, age (e.g., birthdate), gender, interests, contact information, home town, address, the names of the member's family members (e.g., spouse), educational background (e.g., schools, majors, matriculation date, or graduation date), employment history, skills, and professional organizations. This information—generally referred to as member profile information—is stored, for example, in the profile database 324. Similarly, when a representative (e.g., user 152) of an organization initially registers the organization with the social networking service, the representative may be prompted to provide certain information about the organization. This information—generally referred to as company profile information—may be stored, for example, in the profile database 324.

In some example embodiments, the profile data may be processed (e.g., in the background or offline) to generate various additional profile data (e.g., derived profile data). For example, if a member (e.g., user 132) has provided information about various job titles the member has held with the same or different companies, and for how long, this information can be used to infer or derive a member profile attribute indicating the member's overall seniority level or seniority level within a particular company. In certain example embodiments, importing or otherwise accessing data from one or more externally hosted data sources may enhance profile data for both members and organizations. For instance, with companies in particular, financial data may be imported from one or more external data sources and made part of a company's profile.

Once registered, a member (e.g., user 132) may invite other members (e.g., user 152), or be invited by other members, to connect via the social networking service. A “connection” may rely upon a bilateral agreement by the connecting members (e.g., users 132 and 152), such that both members acknowledge the establishment of the connection. Alternatively, according to certain example embodiments, a member (e.g., user 132) may elect to “follow” another member (e.g., user 152). In contrast to establishing a connection (e.g., a bilateral connection), the concept of “following” another member typically is a unilateral operation, and at least in some example embodiments, does not require acknowledgement or approval by the member that is being followed (e.g., user 152). When one member follows another member, the member who is following (e.g., user 132) may receive status updates or other messages published by the member being followed (e.g., user 152), or relating to various activities undertaken by the member being followed. Similarly, when a member (e.g., user 132) follows an organization, the member becomes eligible to receive messages or status updates published on behalf of the organization. For instance, messages or status updates published on behalf of an organization that a member is following will appear in the member's personalized activity or content stream. According to some example embodiments, the various associations and relationships that the members establish with other members, or with other entities and objects, are stored and maintained within a social graph, shown in FIG. 3 as being stored in a social graph database 326.

As a member (e.g., user 132) interacts with the various applications, services and content made available via the social networking service, the member's behavior (e.g., content viewed and links selected) may be monitored, and information concerning the member's behavior may be stored within a behavioral database 328. This information may be used to infer a member's intent, interests, or both, as well as used to classify the member as being in one or more of various categories. For example, if the member (e.g., user 132) performs frequent searches of job listings, thereby exhibiting behavior indicating that the member likely is a job seeker, this information can be used to classify the member as a job seeker. This classification can then be used as a targetable attribute or characteristic for purposes of enabling others (e.g., an advertiser) to target the member for receiving advertisements, messages, or status updates. Accordingly, a company that has available job openings can publish an advertisement or message that is specifically directed to certain members of the social networking service who are likely job seekers, and thus, more likely to be receptive to recruiting efforts.

In addition to the various applications and services provided to the members of the social networking service, consistent with some example embodiments, the social networking system 310 provides an advertisement server module 316. As shown, the advertisement server module 316 may include one or more other modules, for example, a campaign parameters module 318, which may be configured to allow an advertiser to specify various parameters for an advertising campaign. For example, via a user interface of the campaign parameters module 318 (e.g., a user interface generated at least partly by the campaign parameters module 318 and generated at least partly by the user interface module 312), an advertiser may specify or indicate a particular advertisement to be all or part of an advertising campaign. In addition, the advertiser may specify a period of time (e.g., starting date, days of week, duration, and end date) during which that advertising campaign is to be active. Additionally, the advertiser may establish a bid price for the particular advertisement. In certain example embodiments, the bid price may be the amount that the advertiser is willing to pay to have the particular advertisement presented to a member of the social networking service who has attributes, characteristics, or both that satisfy targeting criteria for the advertising campaign. As noted above, such targeting criteria may be initially specified by the advertiser, but may also be automatically and dynamically modified to increase the CTR for that advertising campaign. Accordingly, in addition to providing a bid price, in certain embodiments, the advertiser may specify one or more sets of member attributes and characteristics that define one or more subsets (e.g., segments) of the population of members of the social networking service, who will be eligible (e.g., targeted) for viewing the specified advertisement in the advertising campaign.

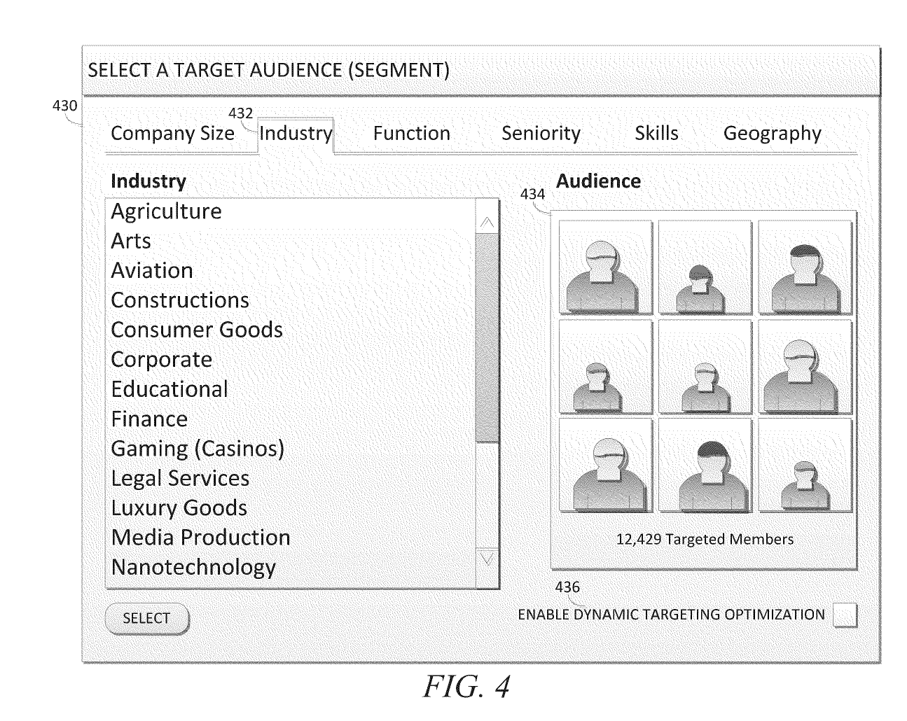

In some example embodiments, the advertisement server module 316 of the social networking system 310 includes what is generally referred to herein as member-targeting module 320. The member-targeting module 320 may be configured to enable an advertiser to establish member-targeting criteria (e.g., initial member-targeting criteria), for example, by selecting from a wide variety of targetable attributes or characteristics. These attributes or characteristics may be attributes or characteristics of members of the social networking service (e.g., descriptors of such members of the social networking service). Accordingly, if an advertiser is aware of the attributes or characteristics that best define one or more subsets (e.g., segments) of members to be targeted for receiving a particular advertisement, the advertiser can specify those targetable attributes or characteristics so that an advertisement will be presented to only those members who satisfy the advertiser-selected targeting criteria for the advertisement, for the advertising campaign, or for both. The member-targeting module 320 may provide a graphical user interface by which the advertiser can select or otherwise specify the particular attributes or characteristics of a targeted subset (e.g., a targeted segment) of the general population of members of the social networking service. An example of such an interface is illustrated in FIG. 4.

FIG. 4 is a user interface diagram illustrating an example of a member-targeting interface 430, which is configured to enable an advertiser to specify the attributes or characteristics that define a subset (e.g., segment) of the population of members of a social networking service who are to be selected for the presentation of an advertisement, consistent with some example embodiments. For example, the member-targeting interface 430 may be an interface (e.g., an interactive window or interactive webpage) that operates in conjunction with the member-targeting module 320 of the social networking system 310. As illustrated in FIG. 4, the member-targeting interface 430 allows a user (e.g., the advertiser) to define the member-targeting criteria for an advertisement by selecting from a wide variety and number of member attributes and characteristics (e.g., company size, industry, function, seniority, skills, and geography). Specifically, by selecting a set of attributes and characteristics as member-targeting criteria, the advertiser may be requesting that the advertisement be served only to members who have or possess the selected attributes and characteristics. Accordingly, an advertiser for a company that develops, manufactures, and sells hardware devices for computer networking may want to target members of the social networking service who work in select industries, at companies of a particular size, and have a job function relating to, for example, information technology.

In the example shown in FIG. 4, the member-targeting criteria include attributes and characteristics in the categories, “Company Size,” “Industry,” “Function,” “Seniority,” “Skills,” and “Geography.” For each category, there may be numerous attributes from which to select. For example, within the category tab 432 for the category “Industry,” the specific attributes may include industries such as “Agriculture,” “Arts,” and “Aviation.” The specific attributes shown in FIG. 4 are presented merely as examples, and any number and variety of other attributes and characteristics not specifically presented in FIG. 4 may be presented in various example embodiments of the member-targeting interface 430. Specifically, in some example embodiments, members may be classified into one or more of a wide variety of groups, based on information or data signals that may be explicit (e.g., a member profile attribute) or inferred, for example, from a pattern of exhibited behaviors, or from information relating to a member's connections. For example, in some example embodiments, a member may be targeted based on that member being classified as a job-seeker or classified as a recruiter.

By selecting a set of attributes and characteristics for use as member-targeting criteria for an advertisement, an advertiser defines an initial targeted subset (e.g., segment) of the population of all members of the social networking service. That is, the advertiser may define a group of members of the social networking service who have attributes or characteristics satisfying the member-targeting criteria (e.g., submitted via the member-targeting interface 430). In the example shown in FIG. 4, a portion 434 of the member-targeting interface 430 displays a summary view of the targeted subset (e.g., as a potential audience for the advertisement), based on the currently selected member-targeting criteria. In the illustrated example, in addition to showing the total number of members in the targeted segment (e.g., “12,429 Targeted Members”), the profile pictures of several of the members in the targeted segment are also presented. By using the member-targeting interface 430, an advertiser may indicate (e.g., establish) several different segments as being eligible to receive and view a particular advertisement.

In certain example embodiments, an advertiser is provided with the option of using the advertiser-selected member-targeting criteria for the entire duration of the advertising campaign, or alternatively, electing to use a dynamic targeting optimization scheme by which the member-targeting criteria will be automatically (e.g., dynamically) modified over time during the advertising campaign to increase the response rate (e.g., CTR) of the members to whom the advertisement is shown. For example, as illustrated in FIG. 4, a user interface element 436 provides an advertiser with the ability to elect the use of (e.g., opt into) the dynamic targeting optimization algorithm or scheme. By selecting or checking a box corresponding to the user interface element 436, an advertiser can elect to use the dynamic targeting scheme in connection with a particular advertising campaign. Alternatively, in some example embodiments, the dynamic targeting optimization scheme may be used with all campaigns by default. In yet other example embodiments, other user interface elements may be presented to allow an advertiser to provide various input information to establish parameters or configuration settings by which the dynamic targeting scheme will operate for the particular advertising campaign. For example, in some example embodiments, an advertiser may provide a parameter to indicate how aggressively new or alternative member-targeting criteria should be tested (e.g., setting or otherwise establishing the number or percentage of impressions for which a dynamically modified member-targeting criterion may be used to test one or more alternative targeted segments of the overall population of members).

Referring again to FIG. 3, the advertisement server module 316 includes a targeting optimization module 322. When an advertiser has elected to use the dynamic targeting scheme, for example, by selecting the user interface element 436 (e.g., a check box), the targeting optimization module 322 operates to establish one or more new subsets of the members of the social networking service (e.g., segments of the total membership of the social networking service) to which the advertisement will be presented, in order to increase the total CTR of the advertisement. The targeting optimization module 322 is configured to establish one or more of such new segments in any combination of two approaches.

As a first approach, during the duration (e.g., course) of the advertising campaign, as the advertisement is presented to members satisfying the initial targeting criteria, some members will select or click the advertisement, and some will not. The targeting optimization module 322 analyzes the various member attributes or characteristics possessed by the set (e.g., subset) of members who do interact with the advertisement, in order to identify specific attributes or characteristics that occur with the most frequency in the member profiles of that set of members. The targeting optimization module 322 may then define one or more new segments, for example, by adding to the member targeting criteria one or more attributes or characteristics not initially selected by the advertiser, but frequently possessed by those members of the targeted segment who have both viewed and selected or clicked on the advertisement. The adding of such attributes or characteristics may be further based on an analysis of historical impression data.

As a second approach, the targeting optimization module 322 may analyze the various attributes or characteristics of the members who were actually presented with the advertisement, but who did not click or select the advertisement. From this group (e.g., subset) of members, the targeting optimization module 322 identifies the most frequently occurring attributes or characteristics in the member profiles of that group of members. The targeting optimization module 322 may then define one or more new segments, for example, by omitting (e.g., excluding) from the member targeting criteria one or more attributes or characteristics frequently possessed by members who have been presented with the advertisement but did not click or select the advertisement. The omitting of such attributes or characteristics may be further based on an analysis of historical impression data.

In some example embodiments, the targeting optimization module 322 may define a new segment for the advertisement by adding to the member targeting criteria one or more member attributes or characteristics that, based on analysis of historical (e.g., actual) impression data, has been frequently possessed by members who have selected or clicked on one or more advertisements that are similar to the advertisement of the current advertising campaign. For example, if analysis of historical impression data indicates that members possessing a particular attribute have shown a higher tendency to click on or select advertisements relating to a particular topic, then the targeting optimization module 322 may define a new segment including the particular attribute when the advertisement in question also relates to the particular topic. By way of example, if a particular advertisement is associated with the topic “Software,” and analysis of historical impression data suggests that members who have the job title “Software Engineer” have exhibited a high tendency to click on or select advertisements relating to the topic “Software,” then the targeting optimization module 322 may define a new segment to target those members who have the job title “Software Engineer.”

As the targeting optimization module 322 automatically or algorithmically defines new segments, an ad server module 323 serves ads (e.g., the advertisement) to those members satisfying the targeting criteria of the new segments. The targeting optimization module 322 may analyze the results of the advertisement impressions relating to the new segments to ascertain whether the CTR for a new segment exceeds some threshold value (e.g., a predetermined threshold rate). For example, the threshold value may be predetermined, selected, calculated, or otherwise obtained based upon the CTR of the initial advertiser-selected segment. As another example, the threshold value may be predetermined, selected, calculated, or otherwise obtained based on some default expected CTR for similar advertisements. In any case, if the CTR for a new segment meets or exceeds the threshold value, the ad server module 323 may continue to serve advertisements (e.g., the advertisement) to members of the new segment. In some example embodiments, the CTR of the new segment may be determined (e.g., by the targeting optimization module 322) to be higher than one or more other CTRs for one or more other segments (e.g., the highest CTR among a group of segments, or within the top five CTRs among the group of segments), in addition to meeting or exceeding the threshold value. In addition, the targeting optimization module 322 may continue to analyze historical impression data to identify possible (e.g., potential) new segments to which the advertisement might be served in order to increase the CTR for the advertisement. In situations in which the new segment does not result in a higher CTR for the advertisement within the new segment (e.g., where the CTR that corresponds to the new segment does not exceed the threshold value), the new segment may be discarded (e.g., rolled back). Specifically, the ad server module 323 may discontinue serving one or more advertisements (e.g., the advertisement) to members of the new segment.

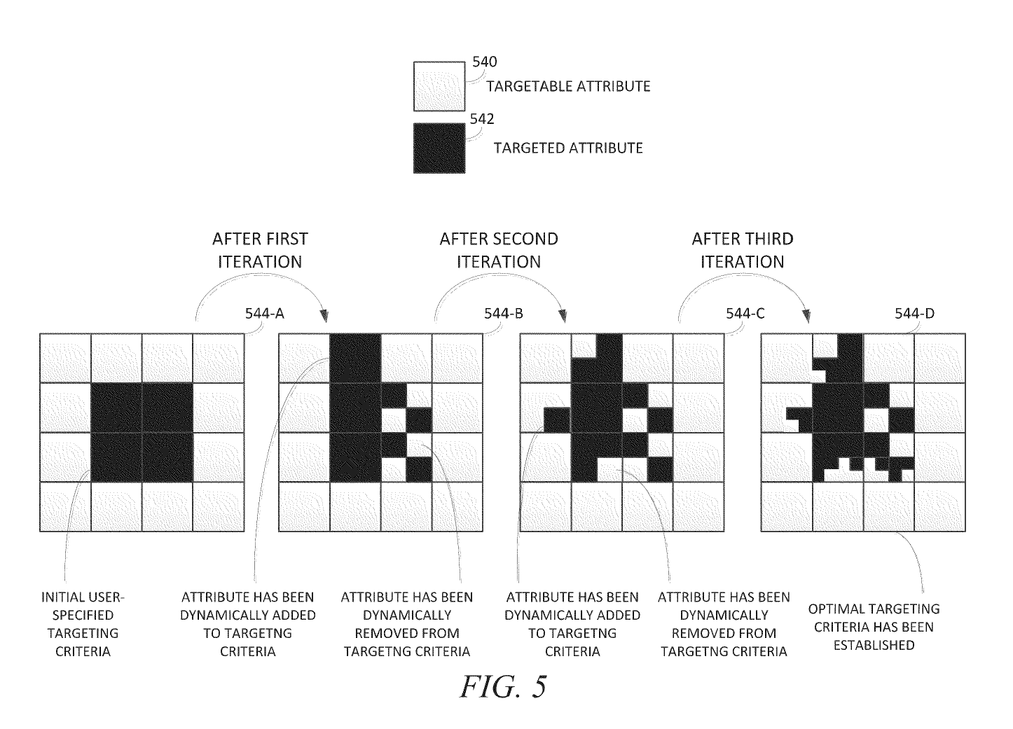

FIG. 5 is a diagram illustrating at a conceptual level how targeting criteria for an advertising campaign may dynamically change over time to increase the CTR for the advertising campaign, consistent with some example embodiments. As illustrated in the legend of FIG. 5, a white square 540 represents a targetable attribute that is not currently selected (e.g., a non-targeted attribute) for inclusion in the targeting criteria of a particular advertising campaign. A targetable attribute is a an attribute (e.g., a feature, descriptor, element, or other characteristic) that can be selected to define a subset (e.g., segment or portion) of the members of a social networking service (e.g., of the total membership population of the social networking service). Instances of the white square 540 each represent a targetable attribute or characteristic that is not currently selected as part of the targeting criteria for a particular advertising campaign. In contrast, a black square 542 represents a targetable attribute that is currently selected (e.g., a targeted attribute) as part of the targeting criteria for the same particular advertising campaign. For instance, given a square representing a specific targetable attribute (e.g., geographical location=San Francisco, Calif.), if the advertiser has selected the targetable attribute as a targeting criterion, the corresponding square is represented with an instance of the black square 542, whereas if the advertiser has not selected the particular attribute, the corresponding square is represented with an instance of the white square 540.

The large squares 544-A, 544-B, 544-C, and 544-D represent the set of targetable and targeted attributes for a particular advertising campaign at different points over a period of time. Referring first to the large square 544-A, the four instances of the black square 542 in the middle represent the initial advertiser-selected targeting criteria (e.g., first targeting criteria). For example, each of the four instances of the black square 542 may represent a particular selected attribute, and the four instances together may define one or more subsets (e.g., segments) of members of the social networking service. Over a first period of time, advertisements (e.g., a particular advertisement within the particular advertising campaign) are presented to those members of the social networking service who have member profiles or otherwise satisfy the current (e.g., initial) member-targeting criteria (e.g., the first targeting criteria).

As advertisements are served and presented to these targeted members of the social network service, information is obtained relating to which of these members have interacted (e.g., clicked on, or otherwise selected) one or more advertisements within the advertising campaign. This information may then be stored and analyzed. Once a sufficient (e.g., predetermined threshold) number of impressions (e.g., presentations of one or more one or more advertisements) have occurred, the obtained information about the members who have been presented with the advertisement is analyzed to identify one or more member profile attributes or characteristics that are shared in common among the high-performing segments of members (e.g., those members that clicked the advertisement). Similarly, this analysis may identify one or more member profile attributes or characteristics that are shared in common among the under-performing (e.g., low-performing) segments (e.g., those members who were presented with the advertisement but did not select the advertisement).

As illustrated by the large square 544-B, during a second period of time, the targeting criteria has been adjusted to exclude certain previously selected attributes or characteristics and to include certain new attributes or characteristics. During the second period of time, advertisements (e.g., a particular advertisement within the particular advertising campaign) are served to those members of the social networking service who satisfy the current (e.g., newly established, in accordance with one or more revisions) member-targeting criteria. The resulting impression data may then be obtained, stored, and analyzed, and the targeting criteria may be further refined to include one or more new attributes or characteristics (e.g., associated with one or more high-performing segments) and omit some attributes (e.g., associated with one or more under-performing segments). This iterative process may be repeated until such time as one or more benefits (e.g., in terms of an increased CTR) are no longer detected or otherwise observed.

In some example embodiments, a small percentage of advertisements may be served to members of the social network service who do not specifically satisfy any of the current member-targeting criteria. In this manner, the response rate (e.g., CTR) of non-targeted members can be tested with a view to identifying additional attributes or segments that are likely to result in a high response rate (e.g. increased CTR).

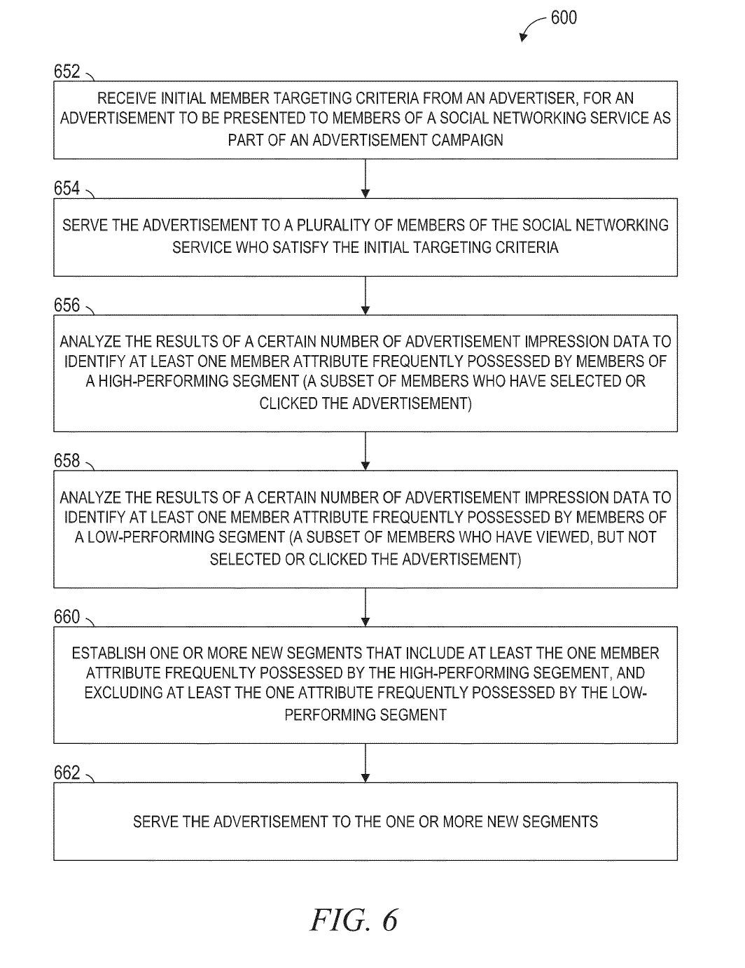

FIG. 6 is a flow diagram illustrating an example of operations that are performed consistent with some example embodiments of a method 600 for dynamically targeting subsets of members of a social networking service. At method operation 652, an advertiser (e.g., user 152) initiates (e.g., seeds) an advertising campaign by specifying or otherwise providing an initial set of one or more member attributes or characteristics for use as member-targeting criteria (e.g., first targeting criteria) for selecting a group (e.g., a first group) of members to whom an advertisement in the advertising campaign will be presented. The initial set of member-targeting criteria may be received by the member-targeting module 320 (e.g., via one or more use interfaces). The campaign parameters module 318 may receive (e.g., via one or more user interfaces) a campaign duration of the advertising campaign, as well as a submission that specifies one or more advertisements to be included in the advertising campaign.

At method operation 654, an advertisement within the advertising campaign is served (e.g., by the ad server module 323) to a plurality (e.g., a first group) of members of the social networking service who satisfy the initial advertiser-specified targeting criteria (e.g., the first targeting criteria). During this period of time in which the advertisement is served (e.g., during an initial period), a subset of the plurality of members (e.g., a high-performing segment) both view the advertisement and click or select the advertisement, while other members in the plurality (e.g., one or more low-performing segments) view the advertisement but do not click or select the advertisement.

At method operation 656, the results are analyzed (e.g., by the targeting optimization module 322) to identify one or more member attributes or characteristics shared in common (e.g., as well as frequently occurring) among the subset of the plurality of members (e.g., among high-performing segment). As noted above, each member of the subset both viewed and clicked or selected the advertisement. In a similar manner, at method operation 658, the results are analyzed (e.g., by the targeting optimization module 322) to identify one or more member attributes or characteristics shared in common (e.g., as well as frequently occurring) among one or more low-performing segments (e.g., one or more subsets of members who viewed but did not click or select the advertisement).

At method operation 660, one or more new segments are defined (e.g., by the targeting optimization module 322) by adding to the targeting criteria a member attribute or characteristic possessed (e.g., frequently) by the subset of the plurality of members (e.g., the high-performing segment). In some example embodiments, one or more existing segments are omitted (e.g., by the targeting optimization module 322) by excluding one or more member attributes or characteristics possessed (e.g., frequently) by one or more low-performing segments. Thus, in some example embodiments, a new segment may be defined by omitting an attribute frequently occurring among members of a low-performing segment. In certain example embodiments, a new segment may be defined by including an attribute previously not selected but frequently occurring among members of the subset of the plurality (e.g., the high-performing segment). In various example embodiments, a new segment may be defined by adding or otherwise including an attribute or characteristic that is similar to an attribute or characteristic that is frequently occurring among the members of the subset of the plurality (e.g., the high-performing segment).

In method operation 662, the advertisement is served (e.g., by the ad server module 323) to the new segment defined by the new (e.g., dynamically modified) member-targeting criteria (e.g., second targeting criteria, generated based on the first targeting criteria, according to operation 660). Method operations 656, 658, 660, and 662 may be repeated one or more times. In certain example embodiments, the repetition may continue until the observed CTR for the advertisement no longer increases for one or more newly defined segments.

According to various example embodiments, one or more of the methodologies described herein may facilitate dynamic targeting of various subsets of the total membership of a social networking service, through dynamic modification of targeting criteria. Moreover, one or more of the methodologies described herein may facilitate increasing the total CTR for an advertising campaign that includes one or more advertisements. Hence, one or more of the methodologies described herein may facilitate optimizing the presentation of an advertisement, as well as reducing the risk of annoying members who are unlikely to click or select the advertisement.

When these effects are considered in aggregate, one or more of the methodologies described herein may obviate a need for certain efforts or resources that otherwise would be involved in dynamic modification of targeting criteria. Efforts expended by an advertiser in optimizing an advertising campaign may be reduced by use of (e.g., reliance upon) a machine that implements one or more of the methodologies described herein. Computing resources used by one or more machines, databases, or devices (e.g., within the network environment 100) may similarly be reduced (e.g., compared to machines, databases, or devices that lack one or more the methodologies described herein). Examples of such computing resources include processor cycles, network traffic, memory usage, data storage capacity, power consumption, and cooling capacity.

FIG. 7 is a block diagram illustrating components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be communicatively coupled (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain solid-state digital microcircuits (e.g., electronic, optical, or both) that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein. In some example embodiments, the processor 702 is a multicore CPU (e.g., a dual-core CPU, a quad-core CPU, or a 128-core CPU) within which each of multiple cores is a separate processor that is able to perform any one or more the methodologies discussed herein, in whole or in part. Although the beneficial effects described herein may be provided by the machine 700 with at least the processor 702, these same effects may be provided by a different kind of machine that contains no processors (e.g., a purely mechanical system, a purely hydraulic system, or a hybrid mechanical-hydraulic system), if such a processor-less machine is configured to perform one or more the methodologies described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., HTTP).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof. In some example embodiments, the instructions 724 for execution by the machine 700 may be carried by a carrier medium. Examples of such a carrier medium include a storage medium and a transient medium (e.g., a signal carrying the instructions 724).

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a CPU or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a CPU configured by software to become a special-purpose processor, the CPU may be configured as respectively different special-purpose processors (e.g., each included in a different hardware module) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. Accordingly, the operations described herein may be at least partially processor-implemented, since a processor is an example of hardware. For example, at least some operations of any method may be performed by one or more processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., apparatus) discussed herein.

A first embodiment provides a method comprising:

receiving a campaign duration of an advertisement and first targeting criteria of the advertisement, the first targeting criteria including a first attribute that is descriptive of some members of a social networking service;
causing the advertisement to be presented to a first group of members of the social networking service, each member of the first group having a different member profile that includes the first attribute;
determining that a subset of the first group has a CTR that corresponds to the advertisement and transgresses a predetermined threshold rate, each member of the subset having a different member profile that includes the first attribute received in the first targeting criteria and also includes a second attribute absent from the first targeting criteria, the determining being performed by a targeting optimization module comprising one or more processors of a machine; and
generating second targeting criteria of the advertisement based on the first targeting criteria by adding the second attribute to the second targeting criteria, the generating being based on the CTR transgressing the predetermined threshold rate, the generating being performed by the targeting optimization module comprising one or more processors of the machine.

A second embodiment provides a method according to the first embodiment, further comprising:

identifying the first group of members of the social networking service based on the first attribute being descriptive of each member of the first group.

A third embodiment provides a method according to the first or second embodiments, further comprising:

detecting that the subset of the first group has a size that exceeds a threshold number of members; and wherein
the determining is based on the size of the subset of the first group exceeding the threshold number of members.

A fourth embodiment provides a method according to any of the first through third embodiments, wherein:

the generating the second targeting criteria includes omitting the first attribute from the second targeting criteria.

A fifth embodiment provides a method according to any of the first through fourth embodiments, further comprising:

causing the advertisement be presented to a second group of members of the social networking service, each member of the second group having a different member profile that includes the second attribute absent from the first targeting criteria.

A sixth embodiment provides a method according to the fifth embodiment, wherein:

each member of the second group has a different member profile from which the first attribute received in the first targeting criteria is absent.

A seventh embodiment provides a method according to the fifth or sixth embodiments, wherein:

the generating of the second targeting criteria and the causing of the advertisement to be presented to the second group are performed prior to expiration of the campaign duration of the advertisement.

An eighth embodiment provides a method according to any of the fifth through seventh embodiments, further comprising:

identifying the second group of members of the social networking service based on the second attribute being descriptive of each member of the second group and descriptive of each member of the subset of the first group.

A ninth embodiment provides a method according to any of the fifth through eighth embodiments, wherein:

the CTR of the subset of the first group is a first CTR; and the method further comprises:
determining that the second group has a second CTR that corresponds to the advertisement; and
generating third targeting criteria of the advertisement based on the second targeting criteria by omitting the second attribute from the third targeting criteria in response to a comparison of the first CTR to the second CTR.

A tenth embodiment provides a method according to the ninth embodiment, wherein:

the second CTR of the second group fails to exceed the first CTR of the first group; and
the omitting of the second attribute from the third targeting criteria is based on the second CTR failing to exceed the first CTR.

An eleventh embodiment provides a method according to the ninth or tenth embodiments, wherein:

the second CTR of the second group fails to exceed the first CTR of the first group by a predetermined threshold percentage; and
the omitting of the second attribute from the third targeting criteria is based on the second CTR failing to exceed the first CTR by the predetermined threshold percentage.

A twelfth embodiment provides a method according to any of the first through eleventh embodiments, wherein:

the first attribute is a first geographical location; and
the second attribute is a second geographical location different from the first geographical location.

A thirteenth embodiment provides a method according to any of the first through twelfth embodiments, wherein:

the first attribute is a geographical location; and
the second attribute is a range of ages.

A fourteenth embodiment provides a method according to any of the first through thirteenth embodiments, wherein:

the first attribute is a range of ages; and
the second attribute is a geographical location.

A fifteenth embodiment provides a method according to any of the first through fourteenth embodiments, wherein:

the first attribute is a first industry; and
the second attribute is a second industry different from the first industry.

A sixteenth embodiment provides a method according to any of the first through fifteenth embodiments, wherein:

the first attribute is a first skill; and
the second attribute is a second skill different from the first skill.

A seventeenth embodiment provides a non-transitory machine-readable storage medium comprising instructions that, when executed by one or more processors of a machine, cause the machine to perform operations comprising:

receiving a campaign duration of an advertisement and first targeting criteria of the advertisement, the first targeting criteria including a first attribute that is descriptive of some members of a social networking service;
causing the advertisement to be presented to a first group of members of the social networking service, each member of the first group having a different member profile that includes the first attribute;
determining that a subset of the first group has a CTR that corresponds to the advertisement and transgresses a predetermined threshold rate, each member of the subset having a different member profile that includes the first attribute received in the first targeting criteria and also includes a second attribute absent from the first targeting criteria, the determining being performed by a targeting optimization module comprising one or more processors of the machine; and
generating second targeting criteria of the advertisement based on the first targeting criteria by adding the second attribute to the second targeting criteria, the generating being based on the CTR transgressing the predetermined threshold rate, the generating being performed by the targeting optimization module comprising one or more processors of the machine.

An eighteenth embodiment provides a non-transitory machine-readable storage medium according to the seventeenth embodiment, wherein the operations further comprise:

detecting that the subset of the first group has a size that exceeds a threshold number of members; and wherein
the determining is based on the size of the subset of the first group exceeding the threshold number of members.

A nineteenth embodiment provides a system comprising: processors;

an advertisement module comprising one or more of the processors and configured to receive a campaign duration of an advertisement and first targeting criteria of the advertisement, the first targeting criteria including a first attribute that is descriptive of some members of a social networking service;
a server module comprising one or more of the processors and configured to cause the advertisement to be presented to a first group of members of the social networking service, each member of the first group having a different member profile that includes the first attribute; and
a targeting optimization module comprising one or more of the processors and configured to:
determine that a subset of the first group has a CTR that corresponds to the advertisement and transgresses a predetermined threshold rate, each member of the subset having a different member profile that includes the first attribute received in the first targeting criteria and also includes a second attribute absent from the first targeting criteria; and
generate second targeting criteria of the advertisement based on the first targeting criteria by adding the second attribute to the second targeting criteria, the generating being based on the CTR transgressing the predetermined threshold rate.

A twentieth embodiment provides a system according to the nineteenth embodiment, wherein:

the server module is configured to cause the advertisement to be presented to a second group of members of the social networking service, each member of the second group having a different member profile that includes the second attribute absent from the first targeting criteria.

A twenty first embodiment provides a carrier medium carrying machine-readable instructions for controlling a machine to carry out the method of any one of the previously described embodiments.

What is claimed is:

1. A method comprising:
receiving a campaign duration of an advertisement and first targeting criteria of the advertisement, the first targeting criteria including a first attribute that is descriptive of some members of a social networking service;
causing the advertisement to be presented to a first group of members of the social networking service, each member of the first group having a different member profile that includes the first attribute;
determining that a subset of the first group has a click-through rate that corresponds to the advertisement and transgresses a predetermined threshold rate, each member of the subset having a different member profile that includes the first attribute received in the first targeting criteria and also includes a second attribute absent from the first targeting criteria, the determining being performed by a targeting optimization module comprising one or more processors of a machine; and
generating second targeting criteria of the advertisement based on the first targeting criteria by adding the second attribute to the second targeting criteria, the generating being based on the click-through rate transgressing the predetermined threshold rate, the generating being performed by the targeting optimization module comprising one or more processors of the machine.

2. The method of claim 1, further comprising:
identifying the first group of members of the social networking service based on the first attribute being descriptive of each member of the first group.

3. The method of claim 1, further comprising:
detecting that the subset of the first group has a size that exceeds a threshold number of members; and wherein
the determining is based on the size of the subset of the first group exceeding the threshold number of members.

4. The method of claim 1, wherein:
the generating the second targeting criteria includes omitting the first attribute from the second targeting criteria.

5. The method of claim 1, further comprising:
causing the advertisement be presented to a second group of members of the social networking service, each member of the second group having a different member profile that includes the second attribute absent from the first targeting criteria.

6. The method of claim 5, wherein:
each member of the second group has a different member profile from which the first attribute received in the first targeting criteria is absent.

7. The method of claim 5, wherein:
the generating of the second targeting criteria and the causing of the advertisement to be presented to the second group are performed prior to expiration of the campaign duration of the advertisement.

8. The method of claim 5, further comprising:
identifying the second group of members of the social networking service based on the second attribute being descriptive of each member of the second group and descriptive of each member of the subset of the first group.

9. The method of claim 5, wherein:
the click-through rate of the subset of the first group is a first click-through rate; and the method further comprises:
determining that the second group has a second click-through rate that corresponds to the advertisement; and
generating third targeting criteria of the advertisement based on the second targeting criteria by omitting the second attribute from the third targeting criteria in response to a comparison of the first click-through rate to the second click-through rate.

10. The method of claim 9, wherein:
the second click-through rate of the second group fails to exceed the first click-through rate of the first group; and
the omitting of the second attribute from the third targeting criteria is based on the second click-through rate failing to exceed the first click-through rate.

11. The method of claim 9, wherein:
the second click-through rate of the second group fails to exceed the first click-through rate of the first group by a predetermined threshold percentage; and
the omitting of the second attribute from the third targeting criteria is based on the second click-through rate failing to exceed the first click-through rate by the predetermined threshold percentage.

12. The method of claim 1, wherein:
the first attribute is a first geographical location; and
the second attribute is a second geographical location different from the first geographical location.

13. The method of claim 1, wherein:
the first attribute is a geographical location; and
the second attribute is a range of ages.

14. The method of claim 1, wherein:
the first attribute is a range of ages; and
the second attribute is a geographical location.

15. The method of claim 1, wherein:
the first attribute is a first industry; and
the second attribute is a second industry different from the first industry.

16. The method of claim 1, wherein:
the first attribute is a first skill; and
the second attribute is a second skill different from the first skill.

17. A non-transitory machine-readable storage medium comprising instructions that, when executed by one or more processors of a machine, cause the machine to perform operations comprising:
receiving a campaign duration of an advertisement and first targeting criteria of the advertisement, the first targeting criteria including a first attribute that is descriptive of some members of a social networking service;
causing the advertisement to be presented to a first group of members of the social networking service, each member of the first group having a different member profile that includes the first attribute;
determining that a subset of the first group has a click-through rate that corresponds to the advertisement and transgresses a predetermined threshold rate, each member of the subset having a different member profile that includes the first attribute received in the first targeting criteria and also includes a second attribute absent from the first targeting criteria, the determining being performed by a targeting optimization module comprising one or more processors of the machine; and
generating second targeting criteria of the advertisement based on the first targeting criteria by adding the second attribute to the second targeting criteria, the generating being based on the click-through rate transgressing the predetermined threshold rate, the generating being performed by the targeting optimization module comprising one or more processors of the machine.

18. The non-transitory machine-readable storage medium of claim 17, wherein the operations further comprise:
detecting that the subset of the first group has a size that exceeds a threshold number of members; and wherein
the determining is based on the size of the subset of the first group exceeding the threshold number of members.

19. A system comprising:
processors;
an advertisement module comprising one or more of the processors and configured to receive a campaign duration of an advertisement and first targeting criteria of the advertisement, the first targeting criteria including a first attribute that is descriptive of some members of a social networking service;
a server module comprising one or more of the processors and configured to cause the advertisement to be presented to a first group of members of the social networking service, each member of the first group having a different member profile that includes the first attribute; and
a targeting optimization module comprising one or more of the processors and configured to:
determine that a subset of the first group has a click-through rate that corresponds to the advertisement and transgresses a predetermined threshold rate, each member of the subset having a different member profile that includes the first attribute received in the first targeting criteria and also includes a second attribute absent from the first targeting criteria; and
generate second targeting criteria of the advertisement based on the first targeting criteria by adding the second attribute to the second targeting criteria, the generating being based on the click-through rate transgressing the predetermined threshold rate.

20. The system of claim 19, wherein:
the server module is configured to cause the advertisement to be presented to a second group of members of the social networking service, each member of the second group having a different member profile that includes the second attribute absent from the first targeting criteria.
